(19) United States
(12) Patent Application Publication
(10) Pub. No.: US 2007/0294441 A1
(43) Pub. Date: Dec. 20, 2007

(54) USB KEYSTROKE MONITORING APPARATUS AND METHOD

(76) Inventor: Felix Anton Harold Collins, Christchurch (NZ)

Correspondence Address: KeyGhost Limited, 109 Montreal Street, Christchurch, 8001, NZ

(21) Appl. No.: 11/762,032

(22) Filed: Aug. 12, 2007

(30) Foreign Application Priority Data
Jun. 14, 2006 (NZ) 547892

(51) Int. Cl. G06F 13/12

(52) U.S. Cl. 710/67

(57) ABSTRACT

An apparatus and method for monitoring USB keystroke data sent between a host (1) and keyboard (4) which allows the differentiation and monitoring between USB data sent at full speed (12 Mbps) and low speed (1.5 Mbps) on a USB data line (2). The differentiation is achieved by detecting when full speed USB data has been sent by detecting the single ended zero (SE0) condition of the previous packet and measuring the pulse width in the subsequent synchronisation sequence and detecting when low speed USB data has been sent by detecting the presence of a preamble packet or measuring the pulse width of the synchronisation sequence. Thus, the monitoring and differentiation between mixed said low speed and said full speed USB data is allowed which enables a USB keystroke recording apparatus (3) to ensure that keystroke data is not missed.

### CROSS-REFERENCE TO RELATED APPLICATIONS

This application claims foreign priority from New Zealand Provisional Patent Application No. 547892, filed Jun. 14, 2006 by the present inventor.

### FIELD OF THE INVENTION

This invention relates to a USB keystroke monitoring apparatus and method. Particularly, but not exclusively, the invention relates to a USB keystroke recording apparatus with improved features including a mechanism for filtering USB keystroke data from a mixed low-speed and full speed data transmission and undetectably recording USB keystroke data in the log.

### BACKGROUND OF THE INVENTION

Commercially available hardware keystroke monitoring devices and software work by recording the keystrokes typed into a log that can be retrieved later by users. USB keystroke monitors for USB keyboards have only recently become commercially available.

Existing models convert the USB keyboard to which it is attached to a generic HID (human interface device) keyboard and pass the communications through in the manner of a proxy. This creates problems when other devices are attached downstream from the device, as the keylogger will disable any devices it does not recognise and also any full speed (12 Mbit/s) or high speed (480 Mbit/s) devices such as a flash disk or webcam. In this case the presence of a logging device attached to the computer becomes obvious.

Present USB keyloggers are also unable to differentiate between various speeds of USB traffic, which can cause problems when monitoring keystrokes by ‘sniffing’ the USB data line, as mixed speed signals can cause loss of data for the keylogger. Therefore, there is need for an apparatus and method that overcomes the problems in the prior art regarding mixed speed transmission of USB data, and allows monitoring and recording of USB keystroke data while remaining undetectable to the host computer.

### OBJECT OF THE INVENTION

It is an object of this invention to provide a hardware apparatus and method that allows the differentiation and recording of keystroke USB data sent at low speed and full speed, or at least provide the public with a useful choice.

It is also an object of this invention to provide a hardware apparatus that enables the undetectable capturing of keystrokes from the USB data stream, or at least provide the public with a useful choice.

It is also an object of this invention to provide a method that enables encrypting and storing of captured USB keystrokes in non-volatile memory, or at least provide the public with a useful choice.

It is also an object of this invention to provide a hardware apparatus and method that records timestamps relating to USB keystroke events, or at least provide the public with a useful choice.

### SUMMARY OF THE INVENTION

In the first aspect the invention provides an apparatus a USB receiver and processor, where the processor includes:
detection means to determine when a full speed (12 Mbps) USB signal has been sent by detecting the single ended zero (SE0) condition of the previous packet and measuring the pulse width in the subsequent synchronisation sequence; and
detection means to determine when a low speed (1.5 Mbps) USB signal has been sent by detecting the presence of a preamble packet or measuring the pulse width of the synchronisation sequence;
   whereby the monitoring and differentiation between mixed low and full speed USB data is allowed.

In a second aspect the invention provides a method of monitoring a USB data line including the steps of:
detecting when a full speed (12 Mbps) USB signal has been sent by detecting the single ended zero (SE0) condition of the previous packet and measuring the pulse width in the subsequent synchronisation sequence; and
detecting when a low speed (1.5 Mbps) USB signal has been sent by detecting the presence of a preamble packet or measuring the pulse width of the synchronisation sequence;
   whereby the monitoring and differentiation between mixed low and full speed USB data is allowed.

Preferably, the apparatus and method allows the monitoring and recording of USB keystroke data with the addition of timestamps at pre-determined intervals.

Preferably the apparatus and method allows data from high speed USB (480 Mb/s) transmission to be recorded and differentiated, as well as different kinds of USB data packets.

### BRIEF DESCRIPTION OF THE DRAWINGS

The invention will be described by way of example only with reference to the drawings, in which:

FIG. 1 shows an apparatus connected to a keyboard to allow monitoring of keystrokes;

FIG. 2 is a block diagram of the basic structure of the invention with the modules that allow operation of the described features including, the USB Receiver, RX SIE CPLD, USB DSP, and LOG DSP.

### DETAILED DESCRIPTION OF THE PREFERRED EMBODIMENTS

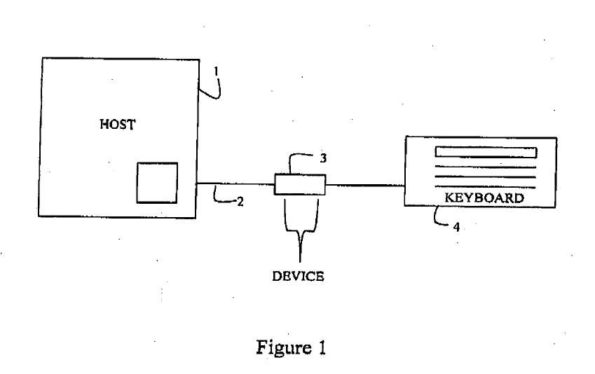

The invention will be described in relation to a USB keyboard-monitoring apparatus. Referring to FIG. 1, the cable 2 connects the host 1 to the keyboard 4 with the apparatus 3 connected inline. In this embodiment the hardware apparatus takes its power by intercepting the host power to the keyboard. The apparatus records all keystrokes typed onto the keyboard and these can be later accessed by a user typing in a password in a suitable program such as Microsoft Notepad. A menu is presented allowing various features, including display of the recorded keystrokes, resetting of clock, erasing of log, setting of time intervals for a time/date stamp.

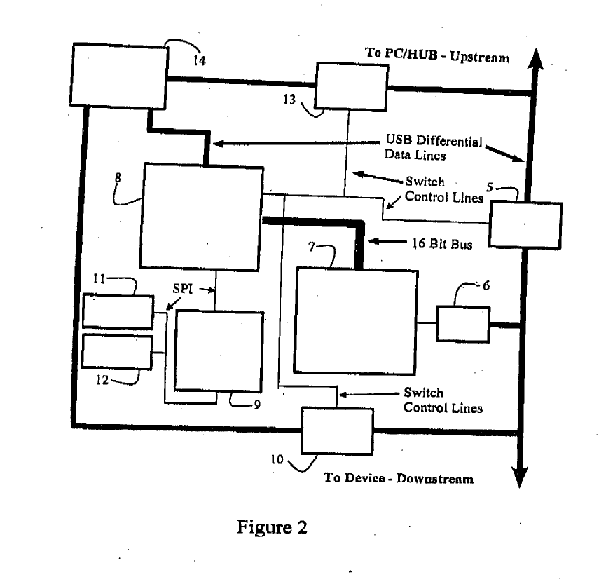

Referring to FIG. 2, in relation to USB keystroke monitoring, the Direct Switch 5, Hub Switch 13 and Keyboard Switch 10, control the connection of the keylogger 3 to the USB Bus. This can be in two modes:

The first mode has the Hub switch 13 and Keyboard Switch 10 open and the Direct Switch 5 closed. In this mode, USB traffic is passed through the keylogger 3 to the downstream devices, which could include a keyboard 4. The only contact the keylogger has with the USB traffic receiving it through the USB Receiver 6.

In the second mode, the Hub switch 13 and Keyboard Switch 10 are closed and the Direct Switch 5 is open. In this mode the downstream devices are connected to the host PC 1 via the USB Hub 14. Likewise the USB DSP 8 is connected to the host PC via the Hub 14. This connection allows the USB DSP 8 to enumerate as a keyboard with the host PC 1 in order to send keystrokes out for displaying a menu.

Operation of Hardware in the Preferred Embodiment:

USB Receiver

This device simply takes the USB line level signals and converts them to 3.3 v logic signals before they are passed on to the RX SIE CPLD 7.

RX SIE CPLD

This device is a programmable logic device that is configured to implement the receiver of a serial interface engine for USB data. The RX SIE CPLD 7 detects whether the USB is running at full or low speed, receives and decodes the serial data and outputs it to the USB DSP 8 via a high speed 16 bit parallel bus.

USB DSP

The USB DSP 8 receives the raw USB data from the RX SIE CPLD 7 and reconstructs the USB packets being sent on the bus. It then filters out the packets relating to enumeration of devices and the packets being sent from keyboard 4 to the host PC 1. The packets relating to enumeration of devices are processed to detect the connection of keyboards. When a keyboard 4 is connected, the keylogger 3 detects and remembers this device so that any packets identified as being sent from this device can be captured for keystroke extraction.

The captured keystrokes are passed on to the LOG DSP 9.

The USB DSP 8 also provides the USB Device 3 functionality needed to emulate a keyboard for the sending of keystrokes to the host computer 1 when the log is requested.

LOG DSP

All data that is logged by the keylogger 3 is encrypted using 128 bit encryption before being stored in the Flash Memory device. The LOG DSP 9 does this encryption and also marks the log with timestamps taken from the Real Time Clock 11. When the log is requested by the user, the LOG DSP 9 sends it to the USB DSP 8 which then sends it on to the host PC 1 in the form of emulated keystrokes.

Operation of Software in Preferred Embodiment:

USB DSP

The software in the USB DSP 8 is mainly concerned with the reconstruction and filtering of the USB traffic. To this end it takes the raw USB traffic, assembles it into packets, collates the packets into USB transactions and composes transfers out of the transactions. Once it has some transfers identified it parses them for transfers concerned with enumeration of newly connected devices. Newly connected keyboard devices in the process of enumeration are detected and recorded in a register of devices to be monitored. Data transfers from devices listed in said register are also parsed. The keystrokes are extracted at this point and sent to the LOG DSP 9.

LOG DSP

The software on the LOG DSP 9 receives the keystrokes from the USB DSP 8, encrypts them and stores them in the flash memory 12. While it is doing this it listens for the user's password. When the password is detected in the stream of keystrokes the LOG DSP 9 signals to the USB DSP 8 to change the connection mode and enumerate as a keyboard. When this is completed it sends a stream of keystrokes out to the host computer (FIG. 1, item 1) that correspond to a menu display. From here the user can select various functions including but not limited to: configuring the timestamping functionality, erasing the log, searching the log and displaying the log or sections of it.

RX SIE CPLD

The source code for the configuration of the RX SIE CPLD 7 is written in Verilog Hardware Description Language. This interface is unique in that it must passively receive the USB data with no prior knowledge of whether the traffic will be a mixture of low speed (1.5 Mbps) and full speed (12 Mbps) or purely low speed. The first case occurs if the keylogger 3 is plugged in above a hub and a low speed device is plugged into the hub. The second occurs if the keylogger is plugged in directly above a low speed device. The point to note here is that a normal USB device will always know in advance whether it is receiving low or full speed. Low speed devices only ever see low speed traffic, full speed devices and USB hubs see low and full speed traffic but do not need to receive the low speed traffic.

In the mixed low/full speed case, the polarity of the USB differential signal lines stays as full speed polarity at all times. Each USB packet transmission starts with a synchronization sequence. The RX SIE CPLD 7 normally measures the width of the first pulse of this sequence to determine the speed of the packet. It knows when to look for the first synchronization pulse by detecting the single ended zero (SE0) condition of the previous packet. In the mixed low/full case however, the speed of the signaling can change without an SE0 being sent. A change to low speed is indicated by the transmission of a special packet called a Preamble packet. The Preamble packet is special in that it does not finish with a single ended zero (SE0) condition as all other USB packets do. So the RX SIE CPLD 7 must detect the sending of the Preamble packet itself rather than measuring the next pulse width. A series of state machines encoded into the RX SIE CPLD encapsulates these rules to control the reception speed.

In the purely low speed case the polarity of the USB differential signal lines stays as low speed and the signaling rate stays as low speed. The RX SIE CPLD 7 simply detects that each packet is transmitted at low speed by measuring the width of the first synchronization pulse.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

I claim:

1. An apparatus comprising a USB receiver and processor, wherein the processor includes:
first detection means to determine when a full speed (12 Mbps) USB data has been sent by detecting the single ended zero (SE0) condition of the previous packet and measuring the pulse width in the subsequent synchronisation sequence; and
second detection means to determine when a low speed (1.5 Mbps) USB data has been sent by detecting the presence of a preamble packet or measuring the pulse width of the synchronisation sequence;
whereby the monitoring and differentiation between mixed said low speed and said full speed USB data is allowed.

2. An apparatus as claimed in claim 1 wherein said apparatus is a USB keystroke recording device.

3. An apparatus as claimed in claim 1 wherein said first and second detection means comprises a complex programmable logic device.

4. An apparatus as claimed in claim 1 wherein said USB data contains keystroke data.

5. A method of monitoring a USB data line including the steps of:
detecting when full speed (12 Mbps) USB data has been sent by detecting the single ended zero (SE0) condition of the previous packet and measuring the pulse width in the subsequent synchronisation sequence; and
detecting when low speed (1.5 Mbps) USB data has been sent by detecting the presence of a preamble packet or measuring the pulse width of the synchronisation sequence;
whereby the monitoring and differentiation between mixed said low speed and said full speed USB data is allowed.

6. An method as claimed in claim 5 wherein said USB data contains keystroke data
